(19) United States
(12) Patent Application Publication
(10) Pub. No.: US 2004/0257371 A1
(43) Pub. Date: Dec. 23, 2004

(54) Pipelined architecture for high speed raster image processor

(76) Inventors: Ralph E. Payne, Dallas, TX (US); Fred J. Reuter, Plano, TX (US)

Correspondence Address: TEXAS INSTRUMENTS INCORPORATED, P O BOX 655474, M/S 3999, DALLAS, TX, 75265

(21) Appl. No.: 10/463,902

(22) Filed: Jun. 17, 2003

(51) Int. Cl. G06T 1/20

(52) U.S. Cl. 345/506

(57) ABSTRACT

A data processing system comprises an input controller and an execution unit operating in a pipelined mode, where the execution unit converts the input from a page description language representation to a display list representation. The display list is further processed by a font cache server, a display list server and a source list server. The output from these servers is coupled to multiple rendering engines, which operate in parallel to generate a bitmap representation of the input data.

### TECHNICAL FIELD OF THE INVENTION

The technical field of this invention is raster image processing and more specifically to a multi-threaded pipelined architecture for the efficient conversion of pages expressed in a page description language into a bitmap in a high speed non-impact printer.

### BACKGROUND OF THE INVENTION

When printing a document, the page to be printed is typically composed electronically using software like QuarkXpress, Framemaker, etc. Internally the page is stored in a vector based graphical representation by these composition tools. This representation is then usually converted to another representation called a page description language (PDL). Some composition tools generate the PDL directly. To print the page, the PDL representation is sent to the printer. Before display or printing, a raster image processor (RIP) converts the PDL representation of the page to a raster (bitmap) representation at the desired resolution.

This conversion process can usually be divided into two stages: interpretation and rendering. Interpretation reduces the original page description to a series of drawing primitives called the display list. Rendering converts these drawing primitives into a bitmap in the frame buffer.

At high resolutions, a significant amount of memory is required to store this bitmap image. As an example, an 8.5″ by 11″ or A4 size page at a resolution of 600 dots per inch (dpi), 8 bits/pixel and 4 color planes will require about 128 megabytes of frame buffer memory.

In order to reduce the memory requirement, the page may be divided into smaller portions or bands. The band size is determined by the available frame buffer memory. Each band is then converted to bitmap form and passed on to the exposure module of the printer to make space for the subsequent bands.

In a typical non-impact printer the exposure module has to be fed with bitmap data at regular intervals. Thus each band must be rendered in a predefined time. As rendering is computationally intensive and is influenced by the page content, such real-time rendering may not be possible for complex bands. In some cases real-time rendering may not be possible even though the bands are not complex. If the available memory is limited, there may not be sufficient room to store the original display list and other information required for rendering the page. If this is the case, each band must be pre-rendered, compressed and stored. After all the bands have been processed and compressed, they are decompressed in real time and fed to the exposure module.

One of the more common page description languages is the Postscript language from Adobe Systems, Inc. The Postscript language is a programming language designed to convey a description of virtually any desired page to a printer or display. Postscript page descriptions are programs that are executed by the Postscript interpreter. The Postscript programs are usually generated by application programs executing on other computers.

Most existing Postscript printers use a single processor to interpret and render a page. Some use a rendering accelerator, but even then the rendering process is single threaded. While page pipelining is commonly used in the art, the various pipeline stages are actually time division multiplexed onto a single resource. As a consequence, the throughput capability of the single processors employed becomes the limiting factor in the printer's throughput.

### SUMMARY OF THE INVENTION

Accordingly, a need has arisen to implement a system that is capable of higher speed processing of printable data expressed in a page description language (PDL) representation, then other implementations using a serial, single processor approach.

The data processing system of the present invention substantially reduces or eliminates the disadvantages associated with prior systems and methods for performing the conversion of page description language representations into bitmap format.

According to one embodiment of the present invention, a data processing system includes a host interface coupled to an execution unit. This execution unit is further coupled to a coprocessor, a master controller and to the rendering unit. The rendering unit further includes a disk buffer coupled to a font cache server, a display list server and a source list server. The output of the servers are coupled to a number of rendering engines operating in parallel, generating bitmap data for the print engine.

### BRIEF DESCRIPTION OF THE DRAWINGS

These and other aspects of this invention are illustrated in the drawings, in which:

FIG. 1 is a simplified diagram of the Texas Instruments TMS320C44 digital signal processor (DSP) suitable for practicing the present invention;

FIG. 2 is a block diagram of the interpretation function of the present invention; and

FIG. 3 is a block diagram of the rendering function of the present invention.

### DETAILED DESCRIPTION OF PREFERRED EMBODIMENTS

Converting PDL input into a bitmap ready to print includes the following major steps:

1. PDL from Host to I/O Protocol;

2. I/O Protocol to ASCII

3. ASCII to Binary Conversion

4. Binary to Display List Conversion

5. Display List to Bitmap Conversion

The above serial flow required to print a page on a non-impact printer can be segmented into two major functions: interpretation; and rendering. The interpretation unit receives the page expressed in a page description language (PDL) such as Postscript. The PDL is then transformed into a display list representing the page to be printed. The rendering unit receives the display list from the interpretation unit and converts it to a bitmap format. The bitmaps are then transferred to the actual print engine, or exposure module in the case of a laser printer, for printing.

The page description languages employed are inherently serial in nature. It is, however, possible to increase throughput by pipelining the I/O control unit and the execution unit that does the actual language interpretation. The rendering unit may be accelerated by employing multiple rendering engines executing in parallel, operating on successive pages or successive bands of a single page depending on the page complexity.

The preferred embodiment of this invention employs multiple Texas Instrument TMS320C44 digital signal processors as the processing elements. The TMS320C44 is a highly integrated digital signal processor capable of transferring 300 Mbytes of data per second. It executes both 40-bit floating point arithmetic and 32-bit integer arithmetic, has two independent address generators and dual 32-bit data busses. The onboard instruction cache allows tight software loops to execute from cache. The dual 32-bit data busses permit accessing two 32-bit data streams simultaneously. Four high speed, 8-bit bi-directional communication ports provide efficient interface capability.

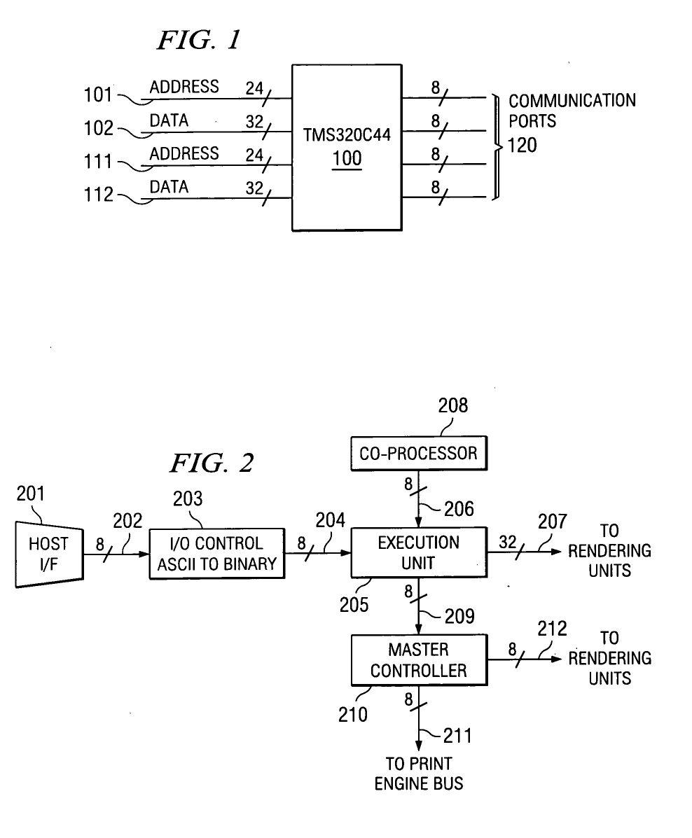

FIG. 1 shows a simplified diagram of this processor 100. Processor 100 includes: address bus 101 and corresponding data bus 102; address bus 111 and corresponding data bus 112; and four 8-bit communications ports 120. While the TMS320C44 is well suited for the implementation of this invention, it is shown only as an example. This example is not to be construed as limiting other implementations using different processing elements.

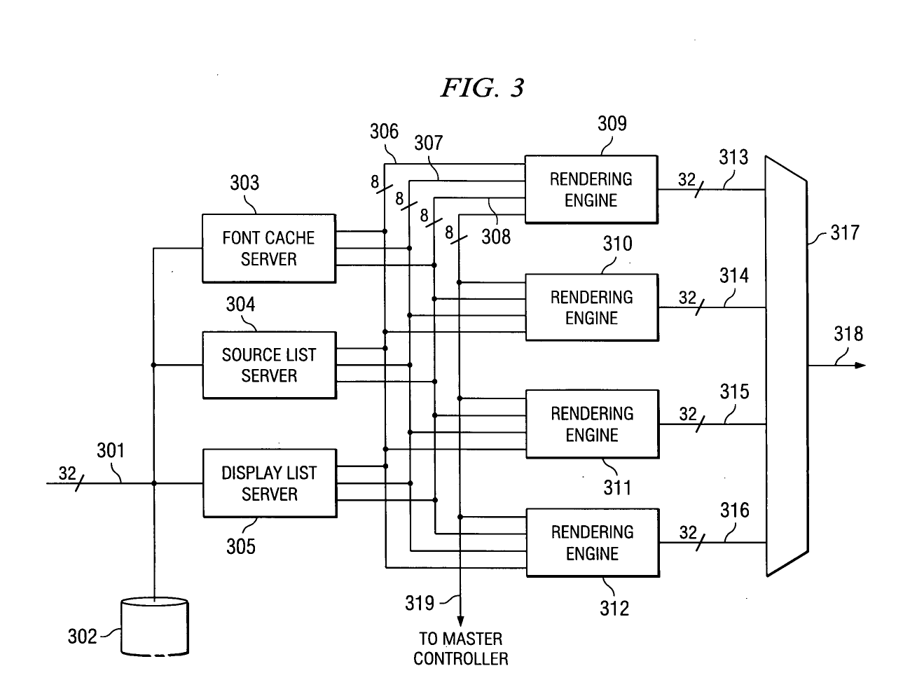

FIGS. 2 and 3 describe the preferred embodiment of this invention. Referring to FIG. 2, host interface block 201 receives data in PDL format. Host interface block 201 implements interface and handshake functions with the host processor. Host interface block 201 transfers the resulting data on 8-bit bus 202 to I/O control module 203. I/O control module 203 has the capability of receiving PDL data at up to 20 Mbytes per second. I/O control module 203 converts the PDL to a binary representation and transfers the binary data stream over the 8-bit bus 204 to execution unit 205. Execution unit 205 communicates with coprocessor unit 208 over the 8-bit bus 206. Coprocessor unit 208 functions as a slave processor under the control of execution unit 205.

Execution unit 205 communicates with master controller 210 over 8-bit bus 209. Master controller 210 handles the overall control and synchronization of the various processing elements. Master controller 210 interfaces the interpretation and rendering units to print engine bus 211.

While the PDL languages are inherently serial in nature, throughput may be increased by the fact that while the execution unit is processing page n, I/O control unit 203 is free to process page n+1 in parallel. To insure data coherency, data structures may be “page tagged” throughout the system described here.

Depending upon the complexity of the page being printed, execution unit 205 may generate a display list for the complete page, or alternately it may convert the display list into the bands required by the print module. The output of execution unit 205 is transferred through 32-bit bus 207 to the rendering unit.

FIG. 3 shows a detailed description of the rendering unit. The rendering unit receives input from the interpretation unit through 32-bit bus 301. Disk storage unit 302 is used to buffer input data. Disk storage unit 302 is required because while the output from the rendering unit is constant, the input from the interpretation unit is variable depending on page complexity.

The buffered data is supplied to font cache server 303, the source list server 304 and the display list server 305. Font cache server 303 collects and scales the various fonts that are being used on the current page. Display list server 304 and source list server 305 collect and manage the display list that is to be rendered into a bitmap. Depending upon the complexity of the page, display list server 304 and source list server 305 may also generate the banded structure required by the print engine. Alternately, the display list may already be in the banded format as generated by the interpretation unit. These processing units are preferably multiple TMS320C44 DSPs with 24 Mbytes of associated memory. Font cache server 303, source list server 304 and display list server 304 collect and buffer all necessary data required by rendering engines 309, 310, 311 and 312 to generate the bitmap representation of the page being printed.

The outputs of font cache server 303, source list server 304 and display list server 305 connect, through common 8-bit busses 306, 307 and 308 to rendering engines 309, 310, 311, and 312. These engines, also comprised of TMS320C44 Digital Signal Processors with 24 Mbytes of associated memory, convert the display list representation on the input busses to the bitmap format required by the print module. The generated bitmap data is transferred, through respective 32-bit busses 313, 314, 315, and 316 to multiplex circuit 317. Rendering engines 309, 310, 311, 312 and multiplex circuit 317 are also connected through 8-bit bus 319 to master controller module 210 of FIG. 2. The data selected by multiplex circuit 317 is then transferred via bus 318 to the print engine.

Although the invention has been described in detail with reference to its preferred embodiments, it is to be understood that this description is by way of example only and is not to be construed in a limiting sense.

Moreover, numerous changes in the details of the embodiments of the invention will be apparent to persons of ordinary skill in the art having reference to this description. It is contemplated that such changes and additional embodiments are within the spirit and true scope of the invention as claimed below.

What is claimed is:

1. A data processing system for converting a page description language representation of a page into a bitmap representation, comprising:
a host interface for receiving ASCII data of a page description language representation of the page from a host processor;
an I/O controller for pre-processing and converting said input ASCII data to a binary representation;
an execution unit for converting said binary representation of the page description language representation of the page to a display list;
a coprocessor for performing defined tasks in parallel with said execution unit;
a master processor for coordinating the data flow between said execution unit and said coprocessor;
a disk storage unit for buffering input data to allow for the variations in input data rate between said execution unit and said coprocessor;
a font cache server for storing the various fonts required to complete and print a current page;
a display list server and a source list server for storing the display list representation of the current page;
a plurality of rendering engines for converting the display list representation to a bitmap format;
a multiplexer circuit for selecting the appropriate data from one of said plurality of rendering engines, and outputting said data to a print engine.

2. The data processing system of claim 1 wherein:
said I/O controller unit and said execution unit operate in a pipelined mode, where the execution unit processes data for page n while the I/O control unit processes data for page n+1.

3. The data processing system of claim 1 wherein:
said execution unit processes said input display list in blocks, where each block contains data required to complete a page.

4. The data processing system of claim 1 wherein:
said execution unit processes said input display list in blocks where each block contains data for a partial page, the size of said partial page corresponding to a band size of said print engine.

5. The data processing system of claim 1 wherein:
said font cache server, said display list server and said source list server process and buffer data for a plurality of pages.

6. The data processing system of claim 1 wherein:
said plurality of rendering engines operate in parallel on succeeding pages.

7. The data processing system of claim 1 wherein;
said plurality of rendering engines operate in parallel on succeeding bands of a single page.
